(19) United States
(12) Patent Application Publication
(10) Pub. No.: US 2009/0139308 A1
(43) Pub. Date: Jun. 4, 2009

(54) Cylinder head gasket and combustion state detector using the same

(76) Inventors: Kenji Matsumoto, Okayama (JP); Eiji Tomita, Okayama (JP); Sadami Yoshiyama, Okayama (JP)

Correspondence Address: WENDEROTH, LIND & PONACK, L.L.P., 1030 15th Street, N.W.,, Suite 400 East, Washington, DC, 20005-1503, US

(21) Appl. No.: 12/285,116

(22) Filed: Sep. 29, 2008

Related U.S. Application Data
(63) Continuation of application No. 12/007,701, filed on Jan. 14, 2008, now abandoned.
Application No. 12/007,701 is a continuation of application No. 11/501,823, filed on Aug. 10, 2006, now abandoned.
Application No. 11/501,823 is a continuation of application No. 10/938,523, filed on Sep. 13, 2004, now abandoned.
Application No. 10/938,523 is a continuation of application No. 10/323,684, filed on Dec. 20, 2002, now abandoned.

(30) Foreign Application Priority Data
Dec. 20, 2001 (JP) 2001-387064

(51) Int. Cl. G01L 23/22

(52) U.S. Cl. 73/35.08; 277/592

(57) ABSTRACT

A cylinder head gasket, interposed between a cylinder head and a cylinder block in an engine, comprises a thin metal plate having a thickness between 0.1 and 2.0 mm, and elastic insulating sheets placed on both surfaces of the thin metal plate and each having a thickness between 0.01 and 0.5 mm, in which: created is a portion at which the thin metal plate is exposed at an inner edge side extending from an inner side of the cylinder block; and also created is an extension portion extending from the cylinder block at an outer edge side extending from an outer side of the cylinder block. Also created is a combustion state detector for detecting a combustion state of an engine, wherein the cylinder head gasket is interposed between the cylinder head and the cylinder block in the engine, the portion at which the thin metal plate is exposed is at the extension portion of the cylinder head gasket, and a signal detecting device is connected thereto.

This application is a Continuation of U.S. Ser. No. 12/007,701, filed Jan. 14, 2008, which is a Continuation of U.S. Ser. No. 11/501,823, filed Aug. 10, 2006, which is a Continuation of U.S. Ser. No. 10/938,523, filed Sep. 13, 2004, now abandoned, which is a Continuation of U.S. Ser. No. 10/323,684, filed Dec. 20, 2002, now abandoned.

### BACKGROUND OF THE INVENTION

1. Field of the Invention

The present invention relates to a cylinder head gasket which is interposed between a cylinder head and a cylinder block in an engine, and has an ion sensor built into the cylinder head gasket for detecting a combustion state of a combustion chamber of the engine, and also relates to a combustion state detector using the same.

2. Description of the Related Art

As a combustion state detector for directly detecting a flame propagation condition within a combustion chamber of an engine, there has been conventionally known a device described in Japanese Patent Application Laid-Open (JP-A) No. 63-66431.

The combustion state detector described in JP-A No. 63-66431 is structured such that a cylinder head gasket having an ion sensor built in an insulation state is interposed between a cylinder head and a cylinder block in an engine. A leading end of an electrode of the ion sensor which is built into the cylinder head gasket faces an interior side of the combustion chamber of the engine. Further, an electric potential is applied to a portion between the electrode of the ion sensor and the cylinder head, the cylinder block or the like corresponding to a ground electrode. Then, a combustion state within the combustion chamber can be detected by measuring an electric current value during a moment when a flame reaches the leading end of the electrode of the ion sensor.

Because of this detector, when the ion sensor is built into the cylinder head gasket interposed between the cylinder head and the cylinder block, it is possible to detect a combustion state of a portion to be detected at a high accuracy without being restricted by a placement position of the ion sensor.

In this case, at a time of interposing the cylinder head gasket between the cylinder head and the cylinder block, in order to improve a gas seal around a cylinder bore, it is necessary to increase surface pressures of upper and lower surfaces of the cylinder gasket.

However, in a case of increasing the surface pressures of the upper and lower surfaces of the cylinder head gasket, there is a case that a crack or the like is generated in a portion of the cylinder head gasket which is in contact with upper and lower sides of the ion sensor due to a thickness of the electrode in the ion sensor built into the cylinder head gasket. When the crack or the like is generated, there is a disadvantage in that an insulating property of the ion sensor cannot be secured.

In order to prevent a crack or the like from being generated, it is considered that the electrode of the ion sensor is made as thin and/or as narrow as possible. However, when the electrode is made thin and/or narrow, there is generated a problem in that a leading end facing a combustion chamber side is melted due to a flame, and a hot surface ignition (a pre-ignition) phenomenon is caused on a basis of the leading end serving as an ignition source, whereby an engine is broken.

### SUMMARY OF THE INVENTION

The present invention is made by taking the problems mentioned above into consideration, and an object of the present invention is to provide an engine combustion state detector in which a crack or the like is not generated in a cylinder head gasket even when surface pressures of upper and lower surfaces of the cylinder head gasket are increased, in spite of that the detector is formed so that an ion sensor is built into the cylinder head gasket, which cylinder head gasket is interposed between a cylinder head and a cylinder block. And, another object of the present invention is to provide a cylinder head gasket suitable for the engine combustion state detector.

That is to say, an object of the present invention is to increase reliability against a flame of a leading end portion of the ion sensor, facing a combustion chamber side, of the engine combustion state detector mentioned before, increase reliability of the cylinder head gasket suitable for the same, maintain this increased reliability, and securely prevent a hot surface ignition from being generated.

In order to solve the problems mentioned above, one aspect of the present invention proposes a cylinder head gasket interposed between a cylinder head and a cylinder block in an engine comprising: a thin metal plate having a thickness between 0.1 and 2.0 mm; and elastic insulating sheets placed on both surfaces of the thin metal plate, each having a thickness between 0.01 and 0.5 mm, wherein a portion at which the thin metal plate is exposed is provided at an inner edge side extending from an inner side of the cylinder block, and an extension portion extending from the cylinder block is created at an outer edge side extending from an outer side of the cylinder block.

The cylinder head gasket according to the present invention is used for an engine combustion state detector, and the thin metal plate serves as an ion sensor. And, the before described portion, at which the thin metal plate is exposed, created at the inner edge side extending from the inner side of the cylinder block, serves as a leading end portion facing a combustion chamber side of the ion sensor, and is in contact with a combustion gas in the combustion chamber. Further, at the before described extension portion of the cylinder head gasket created at the outer edge side of the cylinder head gasket extending from the outer side of the cylinder block, the portion at which the thin metal plate is exposed is created, and a signal detecting device of the combustion state detector is connected hereto.

In the before described cylinder head gasket of the present invention, the before described portion, at which the thin metal plate is exposed created at the inner edge side of the cylinder head gasket extending from the inner side of the cylinder block, is created by removing portions of the elastic insulating sheets from a portion of the cylinder head gasket extending from the inner side of the cylinder block.

Also, the cylinder head gasket can be made by arranging the elastic insulating sheets on both surfaces of the thin metal plate, thereafter punching the sheets into a predetermined shape, and then subjecting the sheets to bead work. By performing this bead work, suitable beads are formed at required portions.

In the present invention, each of the elastic insulating sheets mentioned above comprises an inorganic fiber and/or an organic fiber, an inorganic filler and a rubber binder.

In this case, as the inorganic fiber, a glass fiber, a potassium titanate and the like can be employed.

As the organic fiber, a rock wool, an aramid fiber, a cellulose fiber, a polyester fiber, a polyamide fiber and the like can be employed.

As the inorganic filler, a silica, a clay, a calcium carbonate and the like can be employed.

Further, as the rubber binder, an NBR (nitrile butadiene rubber) is generally employed; however, any one of an acrylic rubber, a silicon rubber, an isoprene rubber, a chloroprene rubber and the like may be additionally employed.

The thin metal plate, on which the elastic insulating sheets are created on both of upper and lower surfaces thereof, may be formed by using an SUS, a spring steel, an SPCC or the like.

Next, in order to achieve the objects mentioned above, one aspect of the present invention proposes an engine combustion state detector for detecting a combustion state of an engine, wherein: a cylinder head gasket, in which elastic insulating sheets comprising an inorganic fiber and/or an organic fiber, an inorganic filler, and a rubber binder are arranged on both surfaces of a thin metal plate, is interposed between a cylinder head and a cylinder block in the engine; created is a portion at which the thin metal plate is exposed on an inner edge side of the said cylinder head gasket extending from an inner side of the cylinder block; created is an extension portion extending from the cylinder block on an outer edge side of the cylinder head gasket extending from an outer side of the cylinder block; created is a portion at which the thin metal plate is exposed at the extension portion; and a signal detecting device is connected to the portion of the thin metal plate exposed at the extension portion.

Further, another aspect of the present invention proposes an engine combustion state detector for detecting a combustion state of an engine, wherein: any one of the before described cylinder head gaskets of the present invention is interposed between a cylinder head and a cylinder block in the engine; created is the portion at which the thin metal plate is exposed at the before described extension portion of the cylinder head gasket; and the signal detecting device is connected to this exposed portion.

A plurality of laminated cylinder head gaskets as described in any one of the preceding aspects of the present invention may be interposed between a cylinder head and a cylinder block. In this case, the signal detecting device is connected to the portion at which the thin metal plate is exposed at the before described extension portion of at least one cylinder head gasket of the plurality of cylinder head gaskets.

According to an aspect that a plurality of cylinder gaskets are interposed in a laminated manner between a cylinder head and a cylinder block in the engine, a good result is achieved in view of a detection accuracy of a combustion state and an improvement of a sealing performance.

In the cylinder head gasket for the combustion state detector according to the present invention mentioned above, since the elastic insulating sheets are provided on both of the upper and lower surfaces of the thin metal plate corresponding to the ion sensor, it is possible to improve a sealing characteristic in addition to durability of the cylinder head gasket.

In the conventional combustion state detector, there has been employed a structure in which an electrode portion is connected to the ion sensor built into the cylinder head gasket; however, in the cylinder head gasket and the combustion state detector according to the present invention, it is possible to omit structure to which an electrode portion is connected as mentioned above. Further, since conduction is directly applied via the thin metal plate, it is possible to accurately and securely detect a combustion state.

Further, since the elastic insulating sheets are provided on both of the upper and lower surfaces of the thin metal plate corresponding to the ion sensor, no unreasonable stress is generated in the cylinder head gasket even when surface pressures of upper and lower surfaces of the cylinder head gasket are increased for a purpose of improving a gas seal around a cylinder bore, so that it is possible to prevent a crack or the like from being generated.

Since the thickness of each elastic insulating sheet is between 0.01 and 0.5 mm, a thickness of the cylinder head gasket is not caused to be changed even when surface pressures of the upper and lower surfaces of the cylinder head gasket are increased for a purpose of improving the gas seal around the cylinder bore, so that a uniform thickness is maintained in a compression portion, and no crack or the like is generated. Accordingly, it is possible to maintain a good insulating property of the thin metal plate corresponding to the ion sensor.

Further, in the thin metal plate corresponding to the ion sensor, since the elastic insulating sheets having the thickness mentioned above are created on both of the upper and lower surfaces thereof, and a thickness of the thin metal plate is between 0.1 and 2.0 mm, there is not generated problems such that a leading end facing a combustion chamber side is melted due to a flame, and the hot surface ignition (the pre-ignition) phenomenon is produced by the leading end corresponding to an ignition source, whereby the engine is broken. Accordingly, it is possible to increase reliability of the leading end portion of the ion sensor facing to the combustion chamber side, and it is possible to maintain this increased reliability.

That is, according to the present invention, it is possible to improve reliability of the cylinder head gasket for the engine combustion state detector as well as to improve a reliability of the engine combustion state detector.

Further, as mentioned above, in the engine combustion state detector proposed by the present invention, since the cylinder head gasket, in which the elastic insulating sheets are provided on both of the upper and lower surfaces of the thin metal plate serving as the ion sensor, is interposed between the cylinder head and the cylinder block in the engine, and created is the portion at which the thin metal plate is exposed at the inner edge side of the cylinder head gasket extending from the inner side of the cylinder block, it is possible to expand an exposed area up to an entire periphery of the combustion chamber in the engine.

### BRIEF DESCRIPTION OF THE DRAWINGS

FIG. 1 is a partly omitted cross sectional view describing a state in which an engine combustion state detector according to one embodiment of the present invention is arranged between a cylinder head and a cylinder block;

FIG. 2 is a plan view of a cylinder head gasket according to one embodiment of the present invention; and

FIG. 3 is a cross sectional view of a part corresponding to an A-A line portion in FIG. 2, which describes a state in which the engine combustion state detector according to the one embodiment of the present invention is arranged between the cylinder head and the cylinder block.

### DESCRIPTION OF THE PREFERRED EMBODIMENT

A description will be given below of a preferred embodiment according to the present invention with reference to the accompanying drawings.

Elastic insulating sheets 32 and 32 containing an NBR (nitrile butadiene rubber), a rock wool and a silica and having a thickness of 0.05 mm each respectively are provided on both of upper and lower surfaces of a thin metal plate 31 having a thickness of 0.5 mm and made of SUS.

Thereafter, these sheets are punched out in a required shape in correspondence to shapes of a cylinder head 1 and a cylinder block 2, between which a cylinder head gasket is interposed. At this time, they are punched out so that an extension portion 33 extending from the cylinder block 2 is created on an outer edge portion of the cylinder head gasket extending from an outer side of the cylinder block 2, when the cylinder head gasket is interposed between the cylinder head 1 and the cylinder block 2. Then, it is necessary to improve a strength, and suitable beads are formed at required portions.

Thereafter, removed are portions of the elastic insulating sheets 32 at an inner edge side of the cylinder head gasket extending from the inner side of the cylinder block 2 when the cylinder head gasket is interposed between the cylinder head 1 and the cylinder block 2, so that the thin metal plate 31 at this portion is exposed. Part of an exposed portion of the thin metal plate 31 corresponds to a portion to be in contact with a combustion gas in a combustion chamber side of an engine.

Cylinder head gasket 3 according to the present invention is manufactured in this manner described above.

In this case, when removing the portions of the elastic insulating sheets 32 from extension portion 33 so as to expose a portion of the thin metal plate 31, the exposed portion of the thin metal plate 31 corresponds to a signal pickup portion, and a signal detecting device is connected thereto.

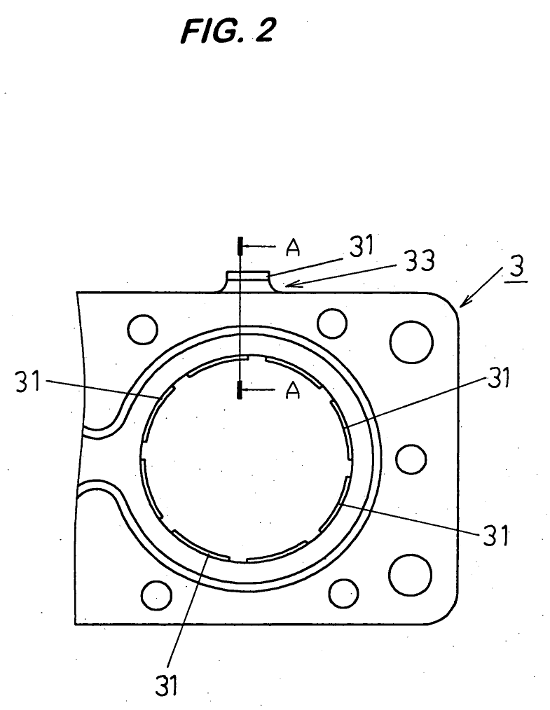

As described above, a structure in a state shown in FIG. 2, in which not only created is a portion at which the thin metal plate 31 is exposed on an inner edge side, but also created is the portion at which the thin metal plate 31 is exposed on the extension portion 33, may also be called the cylinder head gasket according to the present invention.

The cylinder head gasket 3 according to the present invention manufactured in the manner mentioned above is interposed between the cylinder head 1 and the cylinder block 2 in an engine, thereby constructing an engine combustion state detector according to the present invention in the following manner.

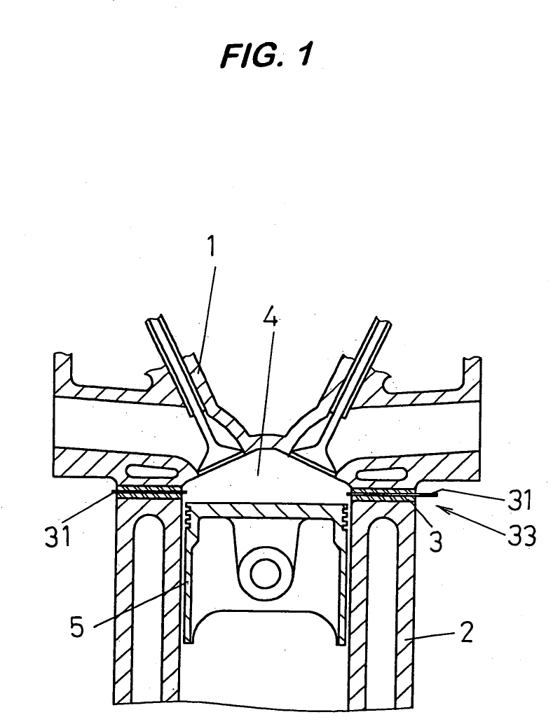

The engine is provided with the cylinder block 2, a piston 5 for reciprocating within the cylinder block 2, and the cylinder head 1 covering an upper portion of the cylinder block 2, as shown in FIG. 1. A combustion chamber 4 is defined by the piston 5 and the cylinder head 1.

The cylinder head gasket 3 structured in the manner mentioned above is interposed between the cylinder block 2 and the cylinder head 1 in the engine as shown in FIG. 1.

Since the cylinder head gasket 3 is manufactured in the manner mentioned above, the thin metal plate 31 is exposed within the combustion chamber 4 in a peripheral manner. This peripherally exposed thin metal plate portion corresponds to a portion which is in contact with combustion gas, and corresponds to an ion sensor.

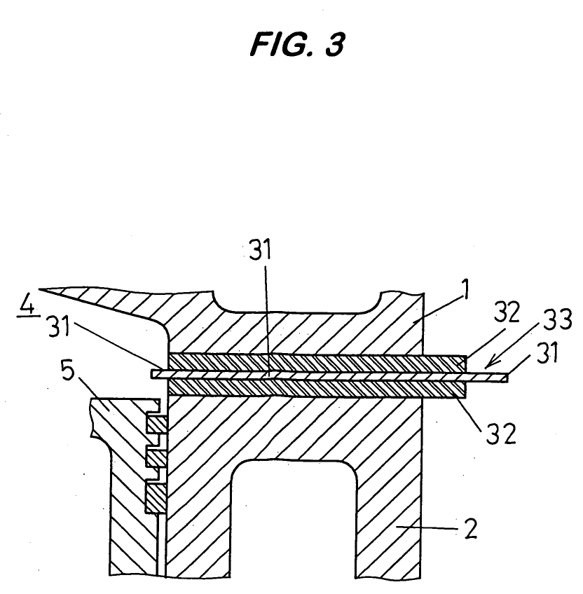

Further, as shown in FIG. 3, the portion, at which portions of the elastic insulating sheets 32 at a portion of the extension portion 33 are removed, and at which the thin metal plate 31 is exposed, corresponds to a signal pickup portion.

The engine combustion state detector according to the present invention is constructed by connecting a conventionally known signal detecting device (not shown) to the signal pickup portion.

An engine combustion state is detected by the combustion state detector according to the present invention in the following manner.

Any one of the cylinder head 1 and the cylinder block 2 is set as a ground electrode, and an electric potential of 90 V is applied between this ground electrode and the portion of the extension portion 33 at which the thin metal plate 31 serving as the ion sensor is exposed.

An electric circuit is formed through a flame band in an ion state during a moment that a flame reaches a portion (a left side in FIG. 3) of the thin metal plate 31 disposed in the combustion chamber 4, whereby an electric current is flowed. A value of this electric current is picked up through the signal detecting device (not shown) connected to the exposed portion of the thin metal plate 31 (the signal pickup portion) at the portion of the extension portion 33, and a combustion state within the combustion chamber 4 is detected by measuring the electric current value. The electric current value can be measured, for example, by amplifying the electric current value picked up through the signal detecting device (not shown) connected to the exposed portion of the thin metal plate (the signal pickup portion) at the portion of the extension portion 33 by use of an amplifier, and processing by use of a signal processor.

Although the present invention has been described with particular reference to a preferred embodiment thereof, it should be understood that various changes and modifications may be made without departing from the spirit and scope of the invention as defined in the appended claims.

1. A cylinder head gasket to be interposed between a cylinder head and a cylinder block in an engine, said cylinder head gasket comprising:
a thin metal plate having
(i) a first surface including an inner part, an outer part, and an intermediate part between said inner part and said outer part, and
(ii) a second surface including an inner part, an outer part, and an intermediate part between said inner part and said outer part;
a first elastic insulating sheet on said intermediate part of said first surface but not on said inner part of said first surface; and
a second elastic insulating sheet on said intermediate part of said second surface but not on said inner part of said second surface,
such that said inner part of said first surface and said inner part of said second surface define an exposed portion of said thin metal plate, and such that said outer part of said first surface and said outer part of said second surface define an extension portion,
with said exposed portion of said thin metal plate extending from an inner side of the cylinder block when said cylinder head gasket is interposed between the cylinder head and the cylinder block, and with said extension portion extending from an outer side of the cylinder block when said cylinder head gasket is interposed between the cylinder head and the cylinder block.

2. The cylinder head gasket according to claim 1, wherein
said thin metal plate has a thickness between 0.1 mm and 2.0 mm, and
said first elastic insulating sheet and said second elastic insulating sheet each have a thickness between 0.01 mm and 0.5 mm.

3. The cylinder head gasket according to claim 2, wherein
said exposed portion of said thin metal plate is created by
(i) removing a portion of material, that is to define said first insulating sheet, from said inner part of said first surface, and
(ii) removing a portion of material, that is to define said second insulating sheet, from said inner part of said second surface.

4. The cylinder head gasket according to claim 3, wherein
said thin metal plate is obtained by
(i) arranging material, that is to define said first insulating sheet, on a first surface of a thin metal substrate,
(ii) arranging material, that is to define said second insulating sheet, on a second surface of the thin metal substrate, then
(iii) punching the thin metal substrate into a predetermined shape, and then
(iv) subjecting this shaped thin metal substrate to bead work.

5. The cylinder head gasket according to claim 4, wherein
said first insulating sheet and said second insulating sheet each comprise an inorganic fiber and/or an organic fiber, an inorganic filler and a rubber binder.

6. The cylinder head gasket according to claim 3, wherein
said first insulating sheet and said second insulating sheet each comprise an inorganic fiber and/or an organic fiber, an inorganic filler and a rubber binder.

7. The cylinder head gasket according to claim 2, wherein
said thin metal plate is obtained by
(i) arranging material, that is to define said first insulating sheet, on a first surface of a thin metal substrate,
(ii) arranging material, that is to define said second insulating sheet, on a second surface of the thin metal substrate, then
(iii) punching the thin metal substrate into a predetermined shape, and then
(iv) subjecting this shaped thin metal substrate to bead work.

8. The cylinder head gasket according to claim 7, wherein
said first insulating sheet and said second insulating sheet each comprise an inorganic fiber and/or an organic fiber, an inorganic filler and a rubber binder.

9. The cylinder head gasket according to claim 2, wherein
said first insulating sheet and said second insulating sheet each comprise an inorganic fiber and/or an organic fiber, an inorganic filler and a rubber binder.

10. The cylinder head gasket according to claim 1, wherein
said first elastic insulating sheet is not on said outer part of said first surface, and
said second elastic insulating sheet is not on said outer part of said second surface.

11. A combustion state detector for detecting a combustion state of an engine, said combustion state detector comprising:
a cylinder head gasket to be interposed between a cylinder head and a cylinder block in the engine, said cylinder head gasket including
(i) a thin metal plate having
(a) a first surface including an inner part, an outer part, and an intermediate part between said inner part and said outer part, and
(b) a second surface including an inner part, an outer part, and an intermediate part between said inner part and said outer part;
(ii) a first elastic insulating sheet on said intermediate part of said first surface but not on said inner part of said first surface nor on said outer part of said first surface, and
(iii) a second elastic insulating sheet on said intermediate part of said second surface but not on said inner part of said second surface nor on said outer part of said second surface,
such that said inner part of said first surface and said inner part of said second surface define an exposed portion of said thin metal plate, and such that said outer part of said first surface and said outer part of said second surface define an extension portion,
with said exposed portion of said thin metal plate extending from an inner side of the cylinder block when said cylinder head gasket is interposed between the cylinder head and the cylinder block, and with said extension portion extending from an outer side of the cylinder block when said cylinder head gasket is interposed between the cylinder head and the cylinder block; and
a signal detecting device connected to said extension portion.

12. The combustion state detector according to claim 11, wherein
said thin metal plate has a thickness between 0.1 mm and 2.0 mm, and
said first elastic insulating sheet and said second elastic insulating sheet each have a thickness between 0.01 mm and 0.5 mm.

13. The combustion state detector according to claim 12, wherein
said exposed portion of said thin metal plate is created by
(i) removing a portion of material, that is to define said first insulating sheet, from said inner part of said first surface, and
(ii) removing a portion of material, that is to define said second insulating sheet, from said inner part of said second surface.

14. The combustion state detector according to claim 13, further comprising:
an additional cylinder head gasket laminated with said cylinder head gasket so as to be interposed, along with said cylinder head gasket, between the cylinder head and the cylinder block in the engine, said additional cylinder head gasket including
(i) a thin metal plate having a thickness between 0.1 mm and 2.0 mm, and also having (a) a first surface including an inner part, an outer part, and an intermediate part between said inner part and said outer part, and
(b) a second surface including an inner part, an outer part, and an intermediate part between said inner part and said outer part;
(ii) a first elastic insulating sheet, having a thickness between 0.01 mm and 0.5 mm, on said intermediate part of said first surface but not on said inner part of said first surface, and
(iii) a second elastic insulating sheet, having a thickness between 0.01 mm and 0.5 mm, on said intermediate part of said second surface but not on said inner part of said second surface,
such that said inner part of said first surface and said inner part of said second surface define an exposed portion of said thin metal plate, and such that said outer part of said first surface and said outer part of said second surface define an extension portion,
with said exposed portion of said thin metal plate extending from an inner side of the cylinder block when said cylinder head gasket and said additional cylinder head gasket are interposed between the cylinder head and the cylinder block, and with said extension portion extending from an outer side of the cylinder block when said cylinder head gasket and said additional cylinder head gasket are interposed between the cylinder head and the cylinder block, and
wherein said exposed portion of said thin metal plate is created by
(i) removing a portion of material, that is to define said first insulating sheet, from said inner part of said first surface, and
(ii) removing a portion of material, that is to define said second insulating sheet, from said inner part of said second surface.

15. The combustion state detector according to claim 12, wherein
said thin metal plate is obtained by
(i) arranging material, that is to define said first insulating sheet, on a first surface of a thin metal substrate,
(ii) arranging material, that is to define said second insulating sheet, on a second surface of the thin metal substrate, then
(iii) punching the thin metal substrate into a predetermined shape, and then
(iv) subjecting this shaped thin metal substrate to bead work.

16. The combustion state detector according to claim 15, further comprising:
an additional cylinder head gasket laminated with said cylinder head gasket so as to be interposed, along with said cylinder head gasket, between the cylinder head and the cylinder block in the engine, said additional cylinder head gasket including
(i) a thin metal plate having a thickness between 0.1 mm and 2.0 mm, and also having (a) a first surface including an inner part, an outer part, and an intermediate part between said inner part and said outer part, and
(b) a second surface including an inner part, an outer part, and an intermediate part between said inner part and said outer part;
(ii) a first elastic insulating sheet, having a thickness between 0.01 mm and 0.5 mm, on said intermediate part of said first surface but not on said inner part of said first surface, and
(iii) a second elastic insulating sheet, having a thickness between 0.01 mm and 0.5 mm, on said intermediate part of said second surface but not on said inner part of said second surface,
such that said inner part of said first surface and said inner part of said second surface define an exposed portion of said thin metal plate, and such that said outer part of said first surface and said outer part of said second surface define an extension portion,
with said exposed portion of said thin metal plate extending from an inner side of the cylinder block when said cylinder head gasket and said additional cylinder head gasket are interposed between the cylinder head and the cylinder block, and with said extension portion extending from an outer side of the cylinder block when said cylinder head gasket and said additional cylinder head gasket are interposed between the cylinder head and the cylinder block, and
wherein said thin metal plate is obtained by
(i) arranging material, that is to define said first insulating sheet, on a first surface of a thin metal substrate,
(ii) arranging material, that is to define said second insulating sheet, on a second surface of the thin metal substrate, then
(iii) punching the thin metal substrate into a predetermined shape, and then
(iv) subjecting this shaped thin metal substrate to bead work.

17. The combustion state detector according to claim 12, further comprising:
an additional cylinder head gasket laminated with said cylinder head gasket so as to be interposed, along with said cylinder head gasket, between the cylinder head and the cylinder block in the engine, said additional cylinder head gasket including
(i) a thin metal plate having a thickness between 0.1 mm and 2.0 mm, and also having (a) a first surface including an inner part, an outer part, and an intermediate part between said inner part and said outer part, and
(b) a second surface including an inner part, an outer part, and an intermediate part between said inner part and said outer part;
(ii) a first elastic insulating sheet, having a thickness between 0.01 mm and 0.5 mm, on said intermediate part of said first surface but not on said inner part of said first surface, and
(iii) a second elastic insulating sheet, having a thickness between 0.01 mm and 0.5 mm, on said intermediate part of said second surface but not on said inner part of said second surface,
such that said inner part of said first surface and said inner part of said second surface define an exposed portion of said thin metal plate, and such that said outer part of said first surface and said outer part of said second surface define an extension portion,
with said exposed portion of said thin metal plate extending from an inner side of the cylinder block when said cylinder head gasket and said additional cylinder head gasket are interposed between the cylinder head and the cylinder block, and with said extension portion extending from an outer side of the cylinder block when said cylinder head gasket and said additional cylinder head gasket are interposed between the cylinder head and the cylinder block.

18. The combustion state detector according to claim 12, wherein
said first insulating sheet and said second insulating sheet each comprise an inorganic fiber and/or an organic fiber, an inorganic filler and a rubber binder.

19. The combustion state detector according to claim 18, further comprising:
an additional cylinder head gasket laminated with said cylinder head gasket so as to be interposed, along with said cylinder head gasket, between the cylinder head and the cylinder block in the engine, said additional cylinder head gasket including
(i) a thin metal plate having a thickness between 0.1 mm and 2.0 mm, and also having (a) a first surface including an inner part, an outer part, and an intermediate part between said inner part and said outer part, and
(b) a second surface including an inner part, an outer part, and an intermediate part between said inner part and said outer part;
(ii) a first elastic insulating sheet, having a thickness between 0.01 mm and 0.5 mm, on said intermediate part of said first surface but not on said inner part of said first surface, said first insulating sheet comprising an inorganic fiber and/or an organic fiber, an inorganic filler and a rubber binder, and
(iii) a second elastic insulating sheet, having a thickness between 0.01 mm and 0.5 mm, on said intermediate part of said second surface but not on said inner part of said second surface, said second insulating sheet comprising an inorganic fiber and/or an organic fiber, an inorganic filler and a rubber binder,
such that said inner part of said first surface and said inner part of said second surface define an exposed portion of said thin metal plate, and such that said outer part of said first surface and said outer part of said second surface define an extension portion,
with said exposed portion of said thin metal plate extending from an inner side of the cylinder block when said cylinder head gasket and said additional cylinder head gasket are interposed between the cylinder head and the cylinder block, and with said extension portion extending from an outer side of the cylinder block when said cylinder head gasket and said additional cylinder head gasket are interposed between the cylinder head and the cylinder block.

20. The combustion state detector according to claim 11, wherein
said first insulating sheet and said second insulating sheet each comprise an inorganic fiber and/or an organic fiber, an inorganic filler and a rubber binder.
